(19) United States
(12) Patent Application Publication
(10) Pub. No.: US 2013/0101824 A1
(43) Pub. Date: Apr. 25, 2013

(54) METHOD FOR PRODUCING LAMINATE, AND LAMINATE

(71) Applicants: Changbo SHIM, Daejeon-shi (KR); Hideaki NEZU, Tsukuba-shi (JP); Shohei AZAMI, Tsukuba-shi (JP)

(72) Inventors: Changbo SHIM, Daejeon-shi (KR); Hideaki NEZU, Tsukuba-shi (JP); Shohei AZAMI, Tsukuba-shi (JP)

(73) Assignee: SUMITOMO CHEMICAL COMPANY, LIMITED, Tokyo (JP)

(21) Appl. No.: 13/617,298

(22) Filed: Sep. 14, 2012

(30) Foreign Application Priority Data
Oct. 21, 2011 (JP) 2011-231924

(51) Int. Cl. B32B 5/28; B32B 37/06

(52) U.S. Cl. 428/221; 156/60

(57) ABSTRACT

The object of the present invention is to provide a laminate superior in dimensional stability, a method for the production thereof, and a circuit substrate using the laminate. There is disclosed a method for producing a laminate, the method including a first step of impregnating a fiber sheet with a liquid composition containing a liquid crystalline polyester and a solvent, and then removing the solvent contained in the fiber sheet to form a resin-impregnated sheet; a second step of stacking a plurality of the resin-impregnated sheets to form an insulative substrate, and then hot press treating the insulative substrate to form a laminated substrate; and a third step of heat treating the laminated substrate at a temperature within the range of from the glass transition temperature of the laminated substrate to the temperature of the glass transition temperature +150° C.

### BACKGROUND OF THE INVENTION

1. Field of the Invention

The present invention relates to a laminate, a method for producing the same, and a circuit substrate made of the laminate.

2. Description of the Related Art

As laminates to be used for electronic circuit substrates, laminates produced by stacking the necessary number of impregnated substrates prepared by impregnating glass woven fabric with a thermosetting resin such as epoxy resin, phenol resin, and unsaturated polyester resin, and, if necessary, further superposing metal foil on the upper face or/and the lower face of the impregnated substrates, followed by hot press molding have heretofore been used.

Along with recent reduction in size of electronic circuits, electronic circuit substrates have been required to have improved dimensional stability, and in order to meet such request, the study of glass woven fabric and aging treatment after molding have been proposed (see, for example, JP-A-59-64350).

### SUMMARY OF THE INVENTION

In a laminate prepared using an impregnated substrate in which a glass woven fabric has been impregnated with a thermosetting resin, such as epoxy resin, phenol resin, and unsaturated polyester resin, molecular movement is suppressed even at temperatures exceeding the glass transition temperature because the thermosetting resin is crosslinked into a three-dimensional network through curing. Therefore, even if a plurality of stacked impregnated substrates impregnated with such a thermosetting resin are subjected to aging treatment at temperatures not lower than the glass transition temperature after curing, the effect of stabilizing dimensions is insufficient.

The present invention was devised in light of the above-mentioned situations, and the problem to be solved thereby is to provide a laminate superior in dimensional stability, a method for producing the same, and a circuit substrate using the laminate.

The present invention is a method for producing of a laminate, the method including the following three steps:

(1) a first step of impregnating a fiber sheet with a liquid composition including a liquid crystalline polyester and a solvent, and then removing the solvent contained in the fiber sheet to form a resin-impregnated sheet;
(2) a second step of stacking a plurality of the resin-impregnated sheets to form an insulative substrate, and then hot press treating the insulative substrate to form a laminated substrate; and
(3) a third step of heat treating the laminated substrate at a temperature within the range of from the glass transition temperature (Tg: the unit is ° C.) of the laminated substrate to the temperature of the glass transition temperature+150° C.

In the present invention, it is preferred that the liquid crystalline polyester has repeating units represented by the following formula (1), repeating units represented by the following formula (2), and repeating units represented by the following formula (3)

—O—Ar¹—CO— (1)

—CO—Ar²—CO— (2)

—X—Ar³—Y— (3)

—Ar⁴—Z—Ar⁵— (4)

wherein Ar¹ represents a phenylene group, a naphthylene group, or a biphenylene group; Ar² and Ar³ each independently represent a phenylene group, a naphthylene group, a biphenylene group, or a group represented by formula (4) provided above; X and Y each independently represent O or NH; one or more hydrogen atoms in Ar¹, Ar², and Ar³ each independently may have been substituted with a halogen atom, an alkyl group, or an aryl group; Ar⁴ and Ar⁵ each independently represent a phenylene group or a naphthylene group; Z represents, O, CO, or SO₂.

In the present invention, it is preferred that the liquid crystalline polyester includes 30 to 60 mol % of the repeating units represented by formula (1), 20 to 35 mol % of the repeating units represented by formula (2), and 20 to 35 mol % of the repeating units represented by formula (3), where the total amount of the repeating units represented by formula (1), the repeating units represented by formula (2), and the repeating units represented by formula (3) is considered to be 100 mol %.

In the present invention, it is preferred that the fiber that constitutes the fiber sheet is glass fiber.

In the present invention, it is preferred that the method further includes, after the third step, a step of forming a metal layer on at least one face of the laminated substrate heat treated in the third step.

In the present invention, it is preferred that the second step is a step of stacking a metal layer on at least one face of the insulative substrate formed in the present step and performing the hot press treatment to form a laminated substrate having the metal layer.

In the present invention, it is preferred that a step of stacking a metal layer on at least one face of the laminated substrate formed in the second step and then performing hot press treatment to form a laminated substrate having the metal layer is inserted to between the second step and the third step.

The present invention is also a laminate including a plurality of resin-impregnated sheets prepared by impregnating a fiber sheet with liquid crystalline polyester, the resin-impregnated sheets having been stacked, wherein the dimensional change between the dimension of the laminate at room temperature and the dimension of the laminate measured after heating the laminate from room temperature to 200° C. over 1 hour, then holding it at 200° C. for 1 hour, and then cooling it from 200° C. to room temperature over 4 hours is within ±0.001%.

Moreover, the present invention is a circuit substrate made of a laminate produced by the above-mentioned method or the above-mentioned laminate.

### ADVANTAGEOUS EFFECTS OF THE INVENTION

According to the present invention, it is possible to provide a laminate superior in dimensional stability, a method for the production thereof, and a circuit substrate using the laminate.

### BRIEF DESCRIPTION OF THE DRAWING

FIG. 1 is a schematic sectional view illustrating one embodiment of the laminate according to the present invention.

### DETAILED DESCRIPTION OF THE PREFERRED EMBODIMENTS

The liquid crystalline polyester in the present invention is one that will exhibit liquid crystallinity in a molten state, and it is preferred to be one that melts at temperature of 450° C. or lower. The liquid crystalline polyesters may be a liquid crystalline polyesteramide, a liquid crystalline polyesterether, a liquid crystalline polyestercarbonate, or a liquid crystalline polyesterimide.

Liquid crystalline polyesters are superior in dimensional stability because mesogens, which are rigid molecular units, linearly have chemical bonds and therefore their whole molecules are rigid. Especially, since aromatic liquid crystalline polyesters are particularly superior in dimensional stability, an all-aromatic liquid crystalline polyester, which is prepared by using only aromatic compounds as feed monomers, is preferred for improving the dimensional stability of a laminate to be obtained.

The following are examples of typical liquid crystalline polyester,

(I) One produced by polymerizing (polycondensing) an aromatic hydroxycarboxylic acid with at least one compound selected from the group consisting of an aromatic dicarboxylic acid, an aromatic dial, an aromatic hydroxyamine, and an aromatic diamine.
(II) One produced by polymerizing two or more types of aromatic hydroxycarboxylic acids.
(III) One produced by polymerizing an aromatic dicarboxylic acid with at least one compound selected from the group consisting of an aromatic diol, an aromatic hydroxyamine, and an aromatic diamine.
(IV) One produced by polymerizing a polyester such as polyethylene terephthalate with en aromatic hydroxycarboxylic acid.

The aromatic hydroxycarboxylic acid, the aromatic dicarboxylic acid, the aromatic diol, the aromatic hydroxyamine, and the aromatic diamine each independently allow their polymerizable derivatives to be used, as a substitute for a part or the whole thereof.

Examples of polymerizable derivatives of compounds having a carboxyl group such as an aromatic hydroxycarboxylic acid and an aromatic dicarboxylic acid include compounds (esters) resulting from the conversion of a carboxyl group into en alkoxycarbonyl group or an aryloxycarbonyl group, compounds (acid halides) resulting from the conversion of a carboxyl group into a haloformyl group, and compounds (acid anhydrides) resulting from the conversion of a carboxyl group into an acyloxycarbonyl group.

Examples of polymerizable derivatives of compounds having a hydroxyl group such as an aromatic hydroxycarboxylic acid, an aromatic diol, and an aromatic hydroxyamine include compounds (acylated bodies) resulting from the conversion of a hydroxyl group into an acyloxyl group by acylation.

Examples of polymerizable derivatives of compounds having an amino group such as an aromatic hydroxyamine and an aromatic diamine include compounds (acylated bodies) resulting from the conversion of an amino group into an acylamino group by acylation.

Preferably, a liquid crystalline polyester has a repeating unit represented by the following formula (1) (hereinafter described as a “repeating unit (1)”), and more preferably, it has a repeating unit (1), a repeating unit represented by the following formula (2) (hereinafter described as a “repeating unit (2)”), and a repeating unit represented by the following formula (3) (hereinafter described as a “repeating unit (3)”):

—O—Ar¹—CO— (1)

—CO—Ar²—CO— (2)

—X—Ar³—Y— (3)

wherein Ar¹ represents a phenylene group, a naphthylene group, or a biphenylylene group; Ar² and Ar³ each independently represent a phenylene group, a naphthylene group, a biphenylylene group, or a group represented by formula (4) provided above; X and Y each independently represent an oxygen atom or an imino group (—NH—); and one or more hydrogen atoms in Ar¹, Ar², and Ar³ may each independently be substituted by a halogen atom, an alkyl group, or an aryl group.

—Ar⁴—Z—Ar⁵— (4)

wherein Ar⁴ and Ar⁵ each independently represent a phenylene group or a naphthylene group; and Z represents an oxygen atom, a sulfur atom, a carbonyl group, a sulfonyl group, or an alkylidene group.

Examples of the halogen atom include a fluorine atom, a chlorine atom, a bromine atom, and an iodine atom.

Examples of the alkyl group include a methyl group, an ethyl group, a n-propyl group, an isopropyl group, a n-butyl group, an isobutyl group, a sec-butyl group, a tert-butyl group, a n-pentyl group, a n-hexyl group, a n-heptyl group, a 2-ethylhexyl group, a n-octyl group, a n-nonyl group, and n-decyl group; the number of carbon atoms thereof is preferably 1 to 10.

Examples of the aryl group include a phenyl group, an o-tolyl group, an m-tolyl group, a p-tolyl group, a 1-naphthyl group, and a 2-naphthyl group; usually, the number of carbon atoms thereof is preferably 6 to 20.

When the hydrogen atom has been substituted by such a group, the number thereof is preferably two or less, more preferably one or less for each of the group represented by Ar¹, Ar², or Ar³.

Examples of the alkylidene group include a methylene group, an ethylidene group, an isopropylidene group, an n-butylidene group, and a 2-ethylhexylidene group; the number of carbon atoms thereof is preferably 1 to 10.

The repeating unit (1) is a repeating unit derived from a prescribed aromatic hydroxycarboxylic acid. As the repeating unit (1), one in which Ar¹ is a p-phenylene group (a repeating unit derived from p-hydroxybenzoic acid) and one in which Ar¹ is a 2,6-naphthylene group (a repeating unit derived from 6-hydroxy-2-naphthoic acid) are preferred.

The repeating unit (2) is a repeating unit derived from a prescribed aromatic dicarboxylic acid. As the repeating unit (2), one in which Ar² is a p-phenylene group (a repeating unit derived from terephthalic acid), one in which Ar² is m-phenylene group (a repeating unit derived from isophthalic acid), one in which Ar² is a 2,6-naphthylene group (a repeating unit derived from 2,6-naphthalenedicarboxylic acid), and one in which Ar² is a diphenyl ether-4,4′-diyl group (a repeating unit derived from a diphenyl ether-4,4′-dicarboxylic acid) are preferred.

The repeating unit (3) is a repeating unit derived from a prescribed aromatic dial, aromatic hydroxylamine, or aromatic diamine. As the repeating unit (3), one in which Ar³ is a p-phenylene group (a repeating unit derived from hydroquinone, p-aminophenol, or p-phenylenediamine), and one in which Ar³ is a 4,4′-biphenylylene group (a repeating unit derived from 4,4′-dihydroxybiphenyl, 4-amino-4′-hydroxybiphenyl, or 4,4′-diaminobiphenyl) are preferred.

The content of the repeating unit (1) is preferably 30 mol % or more, more preferably 30 to 80 mol %, even more preferably 30 to 60=1%, and particularly preferably 30 to 40 mol % where the total amount of the repeating unit (1), the repeating unit (2) and the repeating unit (3) constituting the liquid crystalline polyester is considered to be 100 mol %.

The content of the repeating unit (2) is preferably 35 moles or less, more preferably 10 to 35 mol %, even more preferably 20 to 35 mol %, and particularly preferably 30 to 35 mol % based on the same standard as above.

The content of the repeating unit (3) is preferably 35 mol % or less, more preferably 10 to 35 mol %, even more preferably 20 to 35 mol %, and particularly preferably 30 to 35 mol % based on the same standard as above.

When the content of the repeating unit (1) is 30 mol % or more, heat resistance and strength/rigidity are improved easily, but when the content exceeds 80 mol %, solubility in a solvent decreases easily.

The ratio of the content of the repeating unit (2) to the content of the repeating unit (3), expressed by [the content of the repeating unit (2)]/[the content of the repeating unit (3)] (mol/mol), is preferably from 0.9/1 to 1/0.9, more preferably from 0.95/1 to 1/0.95, and even more preferably from 0.98/1 to 1/0.98.

As to each of the repeating units (1) to (3), the liquid crystalline polyester may have two or more types of repeating units. Although the liquid crystalline polyester may have repeating units other than the repeating units (1) to (3), the content thereof is preferably up to 10 mol %, more preferably up to 5 mol %, relative to the total amount of all the repeating units constituting the liquid crystalline polyester.

It is preferred that the liquid crystalline polyester has a repeating unit in which X and/or Y is an imino group as the repeating unit (3), in other words, has a repeating unit derived from a prescribed aromatic hydroxylamine and/or a repeating unit derived from an aromatic diamine, and it is more preferred to have only a repeating unit in which X and/or Y is an imino group as the repeating unit (3). This configuration affords a liquid crystalline polyester superior in solubility in a solvent.

Preferably, the liquid crystalline polyester is produced by causing feed monomers corresponding to repeating units that constitute the polyester to undergo melt polymerization and then causing the resulting polymer (prepolymer) to undergo solid phase polymerization. A high molecular weight liquid crystalline polyester that is high in heat resistance and strength/rigidity can thereby be produced with good operativity. The melt polymerization may be carried out in the presence of a catalyst; examples of the catalyst include metal compounds such as magnesium acetate, stannous acetate, tetrabutyl titanate, lead acetate, sodium acetate, potassium acetate, and antimony trioxide, and nitrogen-containing heterocyclic compounds such as 4-(dimethylamino)pyridine and 1-methylimidazole; nitrogen-containing heterocyclic compounds are used preferably.

The flow onset temperature of the liquid crystalline polyester is preferably 250° C. or higher, more preferably 250° C. to 350° C., and even more preferably 260° C. to 330° C. When the flow onset temperature is 250° C. or higher, heat resistance and strength/rigidity increase easily, whereas when the flow onset temperature exceeds 350° C., solubility in a solvent easily becomes low or the viscosity of a liquid composition easily becomes high.

The flow onset temperature is also called a flow temperature and that is a temperature at which a liquid crystalline polyester exhibits a viscosity of 4800 Pa·s (48000 Poise) when being molten by increasing the temperature thereof at a rate of 4° C./min under a load of 9.8 MPa (100 kg/cm²) by using a capillary rheometer and then extruded through a nozzle being 1 mm in inner diameter and 10 mm in length. The flow onset temperature can be used as a measure of the molecular weight of a liquid crystalline polyester (see “Liquid Crystalline Polymer—Synthesis, Molding, and Application—” edited by Naoyuki Koide, p. 95, CMC Publishing Co., Ltd., published on Jun. 5, 1987).

### (Solvent)

The liquid composition according to the present invention is preferably a solution in which the liquid crystalline polyester is dissolved in a solvent. As the solvent, one that can dissolve the liquid crystalline polyester to be used, specifically one that can dissolve the liquid crystalline polyester in a concentration ([liquid crystalline polyester]/[liquid crystalline polyester+solvent]) of 1% by mass or more at 50° C. is chosen appropriately and used.

Examples of the solvent in the present invention include halogenated hydrocarbon solvents, such as dichloromethane, chloroform, 1,2-dichloroethane, 1,1,2,2-tetrachloroethane, and o-dichlorobenzene; halogenated phenol solvents, such as p-chlorophenol, pentachlorophenol, and pentafluorophenol; ether solvents, such as diethyl ether, tetrahydrofuran, and 1,4-dioxane; ketone solvents, such as acetone and cyclohexanone; ester solvents, such as ethyl acetate and gamma-butyrolactone; carbonate solvents, such as ethylene carbonate and propylene carbonate; amine solvents, such as triethylamine; nitrogen-containing heterocyclic aromatic compound solvents, such as pyridine; nitrile solvents, such as acetonitrile and succinonitrile; amide solvents, such as N,N-dimethylformamide, N,N-dimethylacetamide, and N-methylpyrrolidone; urea compound solvents, such as tetramethylurea; nitro compound solvents, such as nitromethane and nitrobenzene; sulfur compound solvents, such as dimethyl sulfoxide and sulfolane; and phosphorus compound solvents, such as hexamethyl phosphoramide and tri-n-butyl phosphate; two or more of these may be used in combination.

As the solvent, a solvent primarily containing an aprotic compound, especially an aprotic compound having no halogen atom is preferred because it is low in corrosiveness and easy to handle; the proportion of the aprotic compound in the whole portion of the solvent is preferably 50 to 100% by mass, more preferably 70 to 100% by mass, and even more preferably 90 to 100% by mass.

As the aprotic compound, the use of an amide solvent, such as N,N-dimethylformamide, N,N-dimethylacetamide, and N-methylpyrrolidone, is preferred because it easily dissolves liquid crystalline polyester.

As the solvent, a solvent primarily contains a compound having a dipole moment of 3 to 5 is preferred because it easily dissolves liquid crystalline polyester. The proportion of the compound having a dipole moment of 3 to 5 in the whole portion of the solvent is preferably 50 to 100% by mass, more preferably 70 to 100% by mass, and even more preferably 90 to 100% by mass. In the present invention, particularly, it is preferred to use a compound having a dipole moment of 3 to 5 as the aprotic compound.

As the solvent, a solvent primarily containing a compound having a boiling point of 220° C. or lower at 1 atm is preferred because it is easy to remove. The proportion of the compound having a boiling point of 220° C. or lower at 1 atm in the whole portion of the solvent is preferably 50 to 100% by mass, more preferably 70 to 100% by mass, and even more preferably 90 to 100% by mass; it is preferred to use a compound having a boiling point of 220° C. or lower at 1 atm as the aprotic compound.

The content of the liquid crystalline polyester in the liquid composition is preferably 5 to 60% by mass, more preferably 10 to 50% by mass, and even more preferably 15 to 45% by mass where the combined amount of the liquid crystalline polyester and the solvent is considered to be 100% by mass and it is appropriately adjusted so that a liquid composition having a desired viscosity may be obtained.

The liquid composition may further contain, in addition to the liquid crystalline polyester and the solvent, one or more other components such as fillers, additives, and resins other than the liquid crystalline polyester.

Examples of a filler which the liquid composition may contain include inorganic fillers, such as silica, alumina, titanium oxide, barium titanate, strontium titanate, aluminum hydroxide, and calcium carbonate; and organic fillers, such as cured epoxy resins, crosslinked benzoguanamine resins, and crosslinked acrylic resins, and the content thereof is preferably 0 to 100 parts by mass based on 100 parts by mass of the liquid crystalline polyester.

Examples of an additive which the liquid composition may contain include a leveling agent, a defoaming agent, an antioxidant, a UV absorber, a flame retardant, and a coloring agent, and the content thereof is preferably 0 to 5 parts by mass based on 100 parts by mass of the liquid crystalline polyester.

Examples of a resin other than the liquid crystalline polyester which the liquid composition may contain include thermoplastic resins other than liquid crystalline polyesters, such as polypropylenes, polyamides, polyesters other than liquid crystalline polyesters, polyphenylene sulfides, polyether ketones, polycarbonates, polyether sulfones, polyphenylene ethers, and polyether imides; and thermosetting resins, such as phenol resins, epoxy resins, polyimide resins, and cyanate resins, and the content thereof is preferably 0 to 20 parts by mass based on 100 parts by mass of the liquid crystalline polyester.

The liquid composition can be prepared by mixing a liquid crystalline polyester, a solvent, and other components to be used according to need, at once or in a suitable order. In the event that a filler is used as other components, it is preferred to prepare the liquid composition by dissolving a liquid crystalline polyester in a solvent to obtain a liquid crystalline polyester solution, and then dispersing the filler in this liquid crystalline polyester solution.

Examples of the fiber that constitutes the fiber sheet in the present invention include inorganic fibers, such as glass fiber, carbon fiber, and ceramic fiber; and organic fibers, such as liquid crystalline polyester fiber, other polyester fibers, aramid fiber, and polybenzazole fiber; two or more of these may be used in combination. Especially, glass fiber is preferred as the fiber that constitutes the fiber sheet. Examples of the glass fiber include alkali-containing glass fiber, alkali-free glass fiber, and low dielectric glass fiber.

Although the fiber sheet may be woven textile (woven fabric), knitted fabric, or nonwoven fabric, the sheet is preferably woven fabric because the dimension stability of a resin-impregnated sheet and a laminate increases easily.

Examples of the type of weave of the woven fabric include plain weave, satin weave, twill weave, and basket weave. The weave density of the woven fabric is preferably 10 to 100 fibers/25 mm.

The thickness of the fiber sheet is preferably 10 to 200 μm, more preferably 10 to 180 μm.

The mass of the fiber sheet per unit area is preferably 10 to 300 g/m².

Preferably, the fiber sheet has been surface treated with a coupling agent, such as a silane coupling agent, so that the adhesion to resin may be improved.

Examples of a method for producing a fiber sheet made of such fibers include a method involving dispersing the fibers to constitute the fiber sheet in water, adding a sizing agent such as an acrylic resin according to need, and drying after making paper by a paper machine to obtain a non-woven fabric, and a method of using a known weaving machine.

As a fiber sheet that can be obtained easily from the market, a glass cloth also can be used. As such a glass cloth, various products are marketed as insulating impregnation substrates of electronic components and are available from Asahi-Schwebel Co., Ltd., Nitto Boseki Co., Ltd., Arisawa Manufacturing Co., Ltd., etc. Among commercially available glass clothes, those with preferable thickness include 1035, 1078, 2116, and 7628 in terms of IPC naming.

In the first step according to the present invention, a resin-impregnated sheet is formed by impregnating a fiber sheet with a liquid composition, and then removing the solvent contained in the fiber sheet.

The impregnation of a fiber sheet with a liquid composition is typically carried out by immersing the fiber sheet into an impregnation bath containing the liquid composition. The amount of a liquid crystalline polyester attached to a fiber sheet can be adjusted by adjusting the time for which the fiber sheet is immersed and the speed at which the fiber sheet impregnated with the liquid composition is pulled out of the impregnation bath appropriately according to the content of the liquid crystalline polyester in the liquid composition. The amount of the liquid crystalline polyester attached is usually 30 to 80% by mass, preferably 40 to 70% by mass where the whole mass of the resin-impregnated sheet to be obtained is considered to be 100% by mass.

Subsequently, the solvent is removed from the fiber sheet impregnated with the liquid composition, whereby a resin-impregnated sheet can be obtained. The removal of the solvent is preferably performed by the evaporation of the solvent, and examples of the method therefor include heating, reducing pressure, and air blow-through, which may be used in combination.

Preferably, the resin-impregnated sheet formed in the first step is further heat treated after the removal of the solvent and before the second step. By this operation, the molecular weight of the liquid crystalline polyester contained can be increased, so that the heat resistance of the resin-impregnated sheet and a laminate to be obtained can be enhanced.

Preferably, the heat treatment is carried out under the atmosphere of an inert gas, such as nitrogen gas. The heating temperature is preferably 240 to 330° C., more preferably 250 to 330° C., and even more preferably 260 to 320° C. By adjusting the heating temperature to 240° C. or higher, the heat resistance of the resin-impregnated sheet and a laminate to be obtained is enhanced more. The heating time is preferably 1 to 30 hours, and more preferably 1 to 10 hours. By adjusting the heating time to 1 hour or more, the heat resistance of the resin-impregnated sheet and a laminate to be obtained is enhanced more, whereas by adjusting the heating time to 30 hours or less, the productivity of the laminate is improved more.

In the second step according to the present invention, a plurality of the resin-impregnated sheets formed in the first step are stacked to form an insulative substrate, and then the insulative substrate is hot press treated to form a laminated substrate.

As to the plurality of resin-impregnated sheets to be stacked in the second step, the configurations of the liquid compositions contained therein may be all the same, or only some of them are the same, or all different.

The number of the resin-impregnated sheets to be stacked is not particularly limited if it is two or more.

A laminated substrate can be produced by hot pressing the plurality of insulative substrates stacked in their thickness direction to weld and integrate them to each other.

The temperature at which the insulative substrate composed of the plurality of resin-impregnated sheet stacked is heated is preferably 300° C. to 360° C., more preferably 320° C. to 340° C. The pressure of the pressing is preferably 1 MPa to 20 MPa, more preferably 3 MPa to 10 MPa. The time of the pressing is preferably 5 minutes to 60 minutes, more preferably 10 minutes to 50 minutes. In performing the pressing, it is preferred to perform the pressing while reducing the pressure of the environment where the pressing is done to 5 kPa or less.

In the third step according to the present invention, the laminated substrate produced in the second step is heat treated at a temperature within the glass transition temperature (Tg: the unit is ° C.) of the laminated substrate to the temperature of Tg+150° C.

By heat treating the laminated substrate within this temperature range, it is possible to remove the strain remaining in the laminated substrate due to the hot press treatment at high temperature and high pressure in the second step and it is possible to produce a laminate superior in dimension stability.

The “glass transition temperature of a laminated substrate” as used in the present invention means the glass transition temperature of the resin contained in the laminated substrate and specifically is the glass transition temperature of the laminated substrate measured at a heating rate of 5° C./rain, a frequency of 10 Hz, and an amplitude of 50 μm by using a dynamic viscoelasticity analyzer (“DMAQ800” manufactured by TA Instruments).

When the heat treatment temperature of the third step is lower than the Tg of the laminated substrate, the effect of stabilizing the dimension of a laminate to be obtained is reduced. On the other hand, when the heat treatment temperature exceeds Tg+150° C., the resin constituting the laminated substrate may be degraded.

As to the time of the heat treatment of the third step, the total of the treatment time at temperatures of Tg or higher is preferably 30 minutes to 3 hours, and the treatment is preferably carried out under an atmosphere of an inert gas, such as nitrogen gas.

The method for producing a laminate of the present invention is not restricted to the above-described embodiment, and a conductive layer (metal layer) may be formed on at least one face of the laminated substrate composed of a plurality of resin-impregnated sheets stacked.

When forming the metal layer, the metal layer is formed on a surface of the laminated substrate; it may be formed on only one face of the laminated substrate, that is, on one side, and it also may be formed on both faces, i.e., one face and the opposite face.

Preferably, the material of the metal layer is copper, aluminum, silver, or an alloy containing at least one of these metals, such as a copper alloy, an aluminum alloy and a silver alloy. Especially, copper or a copper allay is preferred because they are better in conductivity and low in cost.

The metal layer is preferably one made of metal foil, more preferably one made of copper foil because the material is easy to handle, the layer can be formed easily, and there is an advantage in economical efficiency.

When forming metal layers on both faces of the laminated substrate, the materials of the metal layers may be either the same or different.

The thickness of a metal layer is preferably 1 to 70 μm, more preferably 3 to 35 μm, even more preferably 5 to 18 μm.

Examples of the method for forming a metal layer include a method in which metal foil is fused to a surface of a laminated substrate by hot pressing or the like, a method in which metal foil is adhered to a surface of a laminated substrate with an adhesive, and a method in which a surface of a laminated substrate is coated with a metal powder or metal particles by a plating process, a screen printing process, or a sputtering process.

The hot pressing to be used in the case of forming a metal layer by stacking metal foil on at least one face of a laminated substrate and then hot pressing is preferably carried out under a vacuum condition, e.g., under a reduced pressure of 0.5 kPa or less.

Although the upper limit of the heating temperature during the hot pressing may be set so that it may be lower than the decomposition temperature of the liquid crystalline polyester used, the upper limit is preferably a temperature being 30° C. or more lower than the decomposition temperature. The decomposition temperature of a liquid crystalline polyester can be measured by a conventional technique, e.g. thermal, weight loss analysis.

In forming a metal layer, the pressure to be applied during the hot pressing is preferably 1 to 30 MPa and the time of the hot pressing is preferably 10 to 60 minutes.

One example of the method for obtaining a laminated substrate having a layer of metal foil (metal layer) on at least one face thereof is a method in which an insulative substrate and the metal foil are superposed in the thickness direction and then hot pressed.

Another example of the method for obtaining a laminated substrate having a layer of metal foil (metal layer) on at least one face thereof is a method in which a further step of superposing metal foil on the laminated substrate obtained in the second step and hot pressing them is provided to between the second step and the third step.

In the case of forming a metal layer by coating a surface of a laminated substrate with a metal powder or metal particles, it is preferred to apply a plating process, and it is more preferred to apply an electroless plating process or an electrolytic plating process. In order to further improve the characteristics of a metal layer, it is preferred to heat treat the metal layer formed by a plating process, and the conditions for the heat treatment may be the same conditions as those used in the above-described case of forming a metal layer by hot pressing.

Still another example of the method for obtaining a laminated substrate having a layer of metal foil (metal layer) on at least one face thereof is a method in which the metal layer is formed by applying, to the laminated substrate obtained in the second step or the laminate obtained in the third step, a process performed at a temperature not higher than the glass transition temperature of the laminated substrate, such as a plating process, a process using an adhesive, a process using screen printing, a vapor deposition process, and a sputtering process.

The laminated substrate with a metal layer obtained before the third step may be heat treated as it is in the third step or may be heat treated in the third step after removing the metal layer with an etchant or the like.

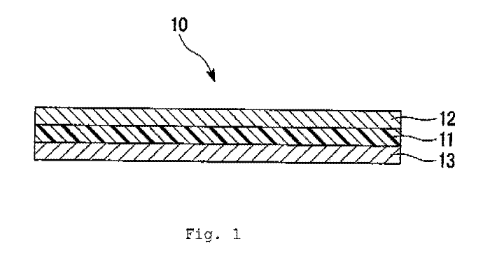

FIG. 1 is a schematic sectional view Illustrating one embodiment of the laminate according to the present invention. A laminate 10 is an item in which a metal layer 12 has been formed on one face of a laminated substrate 11 and a metal layer 13 has been formed on the other face of the laminated substrate 11. The laminated substrate 11 is made of an insulative substrate in which a plurality of resin-impregnated sheets have been stacked. The metal layer 12 and the metal layer 13 are not indispensable and therefore one or both of them may not be formed.

The laminate according to the present invention can be suitably used as a circuit substrate, such as a printed wiring board, by forming a prescribed pattern on a metal layer thereof and, if necessary, laminating two or more pieces thereof.

The laminate according to the present invention is superior in dimensional stability, and the dimensional change between the dimension of the laminate at room temperature and the dimension of the laminate measured after heating the laminate from room temperature to 200° C. over 1 hour, then holding it at 200° C. for 1 hour, and then cooling it from 200° C. to room temperature over 4 hours is within ±0.001%. Therefore, since the laminate according to the present invention exhibits little change in dimension even if it is subjected to heat treatment such as a secondary step of wiring, it does not suffer from generation of distortion of the wiring and it is suitable as a circuit substrate of printed wiring or the like.

The above-mentioned “dimensional change” is measured by a method composed of the following procedures (1) through (6).

(1) The production method of the present invention is carried out to the second step, whereby a laminated substrate in which a metal layer (copper foil) has been formed on at least one face is prepared.
(2) In order to form four copper foil marks of 100 μm in diameter at positions which are equidistant from the center of the above-prepared laminated substrate of 250 mm in length and 250 mm in width, the metal layer (copper foil) of the portions other than the four marks are removed completely by a photo etching method. The four marks are formed at positions such that the distance between points (marks) next to each other is 140 mm and a square is formed when adjacent points are connected. In other words, the marks are formed at positions such that a square formed with the four points contained as vertices is sized 140 mm on each side.
(3) A laminate is prepared by subjecting the laminated substrate on a surface of which the four marks have been formed to the heat treatment of the third step of the production method of the present invention.
(4) The distance between marks next to each other is measured by using a form analyzer (“Quick Vision Hybrid Type 2” manufactured by Mitsutoyo Corporation).
(5) The laminate with the marks is heated at 200° C. (heat treatment conditions: heat treating to 200° C. over 1 hour, holding for 1 hour, and then cooling to room temperature over about 4 hours).
(6) The distance between marks next to each other is measured in the same manner as procedure (2), and the difference of the respective averages (dimension change) is determined from the following Formula (A).

Dimensional change (%)=[(average of the distance between marks after heat treatment)−(average of the distance between marks before heat treatment)]/[average of the distance between marks before heat treatment]×100 Formula (A)

### EXAMPLES

The present invention is described in more detail with reference to Examples below, but the invention is not limited by the Examples. The physical properties in the Examples and the Comparative Examples were measured by the following methods,

### 1. Measurement of Dimensional Change

For each of the laminates of 250 mm×250 min in size having four marks formed on a surface, prepared in Examples 1 to 4 and Comparative Examples 1 and 2 described below, a distance between marks next to each other was measured by using a form analyzer (“Quick Vision Hybrid Type 2” manufactured by Mitsutoyo Corporation). Moreover, heat treatment in which the temperature was raised to 200° C. over 1 hour, then held for 1 hour, and then cooled to room temperature over about 4 hours was applied to each laminate with the marks, then the distance between marks next to each other was measured in the same manner as described above, and the difference of the respective averages (dimension change) was determined from Formula (A) disclosed above.

### 2. Measurement of Flow Onset Temperature of Liquid Crystalline Polyester

Using a Flow Tester (“Model CFT-500”, manufactured by Shimadzu Corporation), about 2 g of a liquid crystal polyester was filled into a cylinder attached with a die including a nozzle having an inner diameter of 1 mm and a length of 10 mm, and the liquid crystal polyester was melted while raising the temperature at a rate of 4° C./min under a load of 9.8 MPa (100 kg/cm²)/extruded through the nozzle, and then the temperature at which a viscosity of 4,800 Pa·s (48,000 poise) was exhibited was measured.

### 3. Measurement of Tg of Laminated Substrate

Tg was measured at a heating rate of 5° C./rain, a frequency of 10 Hz, and an amplitude of 50 μm by using a dynamic viscoelasticity analyzer (“DMA Q800” manufactured by TA Instruments).

### 4. Measurement of Viscosity of Liquid Composition

The viscosity was measured with a No. 21 rotor at a revolution speed of 20 rpm by using a B type viscometer (“TVL-20 type” manufactured by Toki Sangyo Co., Ltd.)

### Production Example 1

### (1) Production of Liquid Crystalline Polyester

A reactor equipped with a stirring device, a torque meter, a nitrogen gas inlet tube, a thermometer, and a reflux condenser was charged with 1976 g (10.5 mol) ref 6-hydroxy-2-naphthoic acid, 1474 g (9.75 mol) of 4-hydroxyacetanilide, 1620 g (9.75 mol) of isophthalic acid, and 2374 g (23.25 mol) of acetic anhydride, and the gas in the reactor was replaced with nitrogen gas. Under stirring under a nitrogen gas flow, the temperature was raised from room temperature to 150° C. over 15 minutes, followed by refluxing at 150° C. for 3 hours. Subsequently, the temperature was raised from 150° C. to 300° C. over 2 hours and 50 minutes while by-produced, distilled acetic acid and unreacted acetic anhydride were distilled off. After the temperature was kept at 300° C. for 1 hour, the contents were taken out of the reactor and cooled to room temperature. The resulting solid was pulverized with a pulverizer, whereby a powdery prepolymer was obtained. The flow onset temperature of this prepolymer was 235° C. Subsequently, the prepolymer was heated from room temperature to 223° C. over 6 hours under a nitrogen atmosphere, and then the temperature was kept at 223° C. for 3 hours, whereby solid phase polymerization was carried out. Then, the mixture was cooled, so that a powdery liquid crystalline polyester was obtained. The flow onset temperature of this liquid crystalline polyester was 270° C.

### (2) Production of Liquid Composition

A liquid crystalline polyester solution was obtained by adding 2200 g of the liquid crystalline polyester produced above to 7800 g of N,N-dimethylacetamide, and then heating at 100° C. for 2 hours. Into this liquid crystalline polyester solution, spherical silica (“MP-8FS” produced by Tatsumori Ltd.) was dispersed in an amount of 20% by volume relative to the liquid crystalline polyester, whereby a liquid composition was obtained. For the liquid composition, a viscosity was measured at a measurement temperature of 23° C. and found to be 0.2 Pa·s (200 cP).

### Example 1

A resin-impregnated sheet was obtained by immersing a glass cloth (produced by Nitto Boseki Co., Ltd., 45 μm in thickness, IPC name: 1078) in the liquid composition obtained in Production Example 1, and then evaporating the solvent at 160° C. by using a hot air dryer. The total content of the spherical silica and the liquid crystalline polyester in the resin-impregnated sheet was 56% by mass. Subsequently, a resin-impregnated sheet was obtained by performing heat treatment at 290° C. for 3 hours under a nitrogen gas atmosphere by using a hot air dryer. The thickness of the resin-impregnated sheet was 64 μm in average.

Five pieces of this resin-impregnated sheet were stacked and copper foil (“3EC-VLP” produced by Mitsui Mining and Smelting Co., Ltd.) was disposed on both sides and pressed at 340° C. for 30 minutes under a pressure of 10 MPa by using a high-temperature vacuum pressing machine (“KVHC-PRESS” manufactured by Kitagawa Seiki Co., Ltd., 300 mm in length, 300 mm in width), whereby a laminated substrate of 250 mm on each side made of the resin-impregnated sheet with the metal layers was obtained. The thickness of the laminated substrate excluding the metal layers was 272 μm in average.

For the laminated substrate obtained, a Tg (glass transition temperature) was measured at a heating rate of 5° C./min, a frequency of 10 Hz, and an amplitude of 50 μm by using a dynamic viscoelasticity analyzer (“DMA Q800” manufactured by TA Instruments) and found to be 225° C.

Subsequently, in order to form four copper foil marks of 100 μm in diameter at positions which are equidistant from the center of the above-prepared laminated substrate of 250 mm in length and 250 mm in width, the metal layer (copper foil) of the portions other than the four marks were removed completely by a photo etching method. The four marks were formed at positions such that the distance between points (marks) next to each other was 140 mm and a square was formed when adjacent points were connected,

Subsequently, the laminated substrate obtained was subjected to heat treatment at 250° C. In the heat treatment at 250° C., the temperature was raised up to 250° C. at a rate of 5° C./min and then held for 1 hour. A laminate was produced via the above-described steps.

### Example 2

A laminate was produced by preparing a laminated substrate in the same manner as Example 1 and then applying heat treatment at 300° C. to the resulting laminated substrate. In the heat treatment at 300° C., the temperature was raised up to 300° C. at a rate of 5° C./rain and then held for 1 hour.

### Example 3

A resin-impregnated sheet was obtained by immersing a glass cloth (produced by Nitto Boseki Co., Ltd., 96 μm in thickness, IPC name: 2116) in the liquid composition obtained in Production Example 1, and then the evaporating the solvent at 160° C. by using a hot air dryer. The total content of the spherical silica and the liquid crystalline polyester in the resin-impregnated sheet was 47% by mass. Subsequently, a resin-impregnated sheet was obtained by performing heat treatment at 290° C. for 3 hours under a nitrogen gas atmosphere by using a hot air dryer. The thickness of the resin-impregnated sheet was 114 μm in average.

Three pieces of this resin-impregnated sheet were stacked and copper foil (“3EC-VLP” produced by Mitsui Mining and Smelting Co., Ltd.) was disposed on both sides and pressed at 340° C. for 30 minutes under a pressure of 10 MPa by using a high-temperature vacuum pressing machine (“KVHC-PRESS” manufactured by Kitagawa Seiki Co., Ltd., 300 mm in length, 300 mm in width), whereby a laminated substrate of 250 mm on each side made of the resin-impregnated sheet with the metal layers was obtained. The thickness of the laminated substrate excluding the metal layers was 253 μm in average.

For the laminated substrate obtained, a Tg (glass transition temperature) was measured at a heating rate of 5° G/min, a frequency of 10 Hz, and an amplitude of 50 μM by using a dynamic viscoelasticity analyzer (“DMA Q800” manufactured by TA Instruments) and found to be 223° C.

Subsequently, in order to form four copper foil marks of 100 μm in diameter at positions which are equidistant from the center of the above-prepared laminated substrate of 250 mm in length and 250 mm in width, the metal layer (copper foil) of the portions other than the four marks were removed completely by a photo etching method. The four marks were formed at positions such that the distance between points (marks) next to each other was 140 mm and a square was formed when adjacent points were connected.

Subsequently, a laminate was produced by applying heat treatment at 250° C. to the resulting laminated substrate. In the heat treatment at 250° C., the temperature was raised up to 250° C. at a rate of 5° C./rain and then held for 1 hour.

### Example 4

A laminate was produced by preparing a laminated substrate in the same manner as Example 3 and then applying heat treatment at 300° C. to the resulting laminated substrate. In the heat treatment at 300° C., the temperature was raised up to 300° C. at a rate of 5° C./min and then held for 1 hour.

### Comparative Example 1

A laminated substrate prepared in the same manner as Example 1 was considered to be a laminate without performing heat treatment.

### Comparative Example 2

A laminated substrate prepared in the same manner as Example 3 was considered to be a laminate without performing heat treatment.

For each of the laminates of Examples 1 to 4 and Comparative Examples 1 and 2, a dimensional change was measured.

Results are shown in Table 1.

TABLE 1

| | | | | | Comparative | |
|---|---|---|---|---|---|---|
| | Example | | | | Example | |
| | 1 | 2 | 3 | 4 | 1 | 2 |
| Tg of laminated | 225 | 225 | 223 | 223 | 225 | 223 |
| substrate (° C.) | | | | | | |
| Temperature of | 250 | 300 | 250 | 300 | — | — |
| heat treatment | | | | | | |
| of laminated | | | | | | |
| substrate (° C.) | | | | | | |
| Dimensional | −0.0001 | −0.0001 | −0.0001 | −0.0003 | −0.0031 | −0.0023 |
| change (%) | | | | | | |

From the results given in Table 1, it was confirmed that the laminates produced in Examples 1 to 4, which are the production method of the present invention, are smaller in dimensional change and therefore superior in dimensional stability as compared with the laminates of Comparative Examples 1 and 2.

1. A method for producing of a laminate, the method comprising the following three steps:
(1) a first step of impregnating a fiber sheet with a liquid composition comprising a liquid crystalline polyester and a solvent, and then removing the solvent contained in the fiber sheet to form a resin-impregnated sheet;
(2) a second step of stacking a plurality of the resin-impregnated sheets to form an insulative substrate, and then hot press treating the insulative substrate to form a laminated substrate; and
(3) a third step of heat treating the laminated substrate at a temperature within the range of from the glass transition temperature of the laminated substrate to the temperature of the glass transition temperature+150° C.

2. The method for producing a laminate according to claim 1, wherein the liquid crystalline polyester has repeating units represented by the following formula (1), repeating units represented by the following formula (2), and repeating units represented by the following formula (3):
—O—Ar¹—CO— (1)
—CO—Ar²—CO— (2)
—X—Ar³—Y— (3)
—Ar⁴—Z—Ar⁵— (4)
wherein Ar¹ represents a phenylene group, a naphthylene group, or a biphenylene group; Ar² and Ar³ each independently represent a phenylene group, a naphthylene group, a biphenylene group, or a group represented by formula (4) provided above; X and Y each independently represent O or NH; one or more hydrogen atoms in Ar¹, Ar², and Ar³ each independently may have been substituted with a halogen atom, an alkyl group, or an aryl group; Ar⁴ and Ar⁵ each independently represent a phenylene group or a naphthylene group; Z represents O, CO, or SO₂.

3. The method for producing a laminate according to claim 2, wherein the liquid crystalline polyester comprises 30 to 60 mol % of the repeating units represented by formula (1), 20 to 35 mol % of the repeating units represented by formula (2), and 20 to 35 mol % of the repeating units represented by formula (3), where the total amount of the repeating units represented by formula (1), the repeating units represented by formula (2), and the repeating units represented by formula (3) is considered to be 100 mol %.

4. The method for producing a laminate according to claim 1, wherein the fiber that constitutes the fiber sheet is glass fiber.

5. The method for producing a laminate according to claim 1, wherein the method further comprises, after the third step, a step of forming a metal layer on at least one face of the laminated substrate heat treated in the third step.

6. The method for producing a laminate according to claim 1, wherein the second step is a step of stacking a metal layer on at least one face of the insulative substrate formed in the present step and performing the hot press treatment to form a laminated substrate having the metal layer.

7. The method for producing a laminate according to claim 1, wherein a step of stacking a metal layer on at least one face of the laminated substrate formed in the second step and then performing hot press treatment to form a laminated substrate having the metal layer is inserted to between the second step and the third step.

8. A laminate comprising a plurality of resin-impregnated sheets prepared by impregnating a fiber sheet with liquid crystalline polyester, the resin-impregnate sheets having been stacked, wherein the dimensional change between the dimension of the laminate at room temperature and the dimension of the laminate measured after heating the laminate from room temperature to 200° C. over 1 hour, then holding it at 200° C. for 1 hour, and then cooling it from 200° C. to room temperature over 4 hours is within ±0.001%.

9. A circuit substrate made of a laminate produced by the production method according to claim 1.

10. A circuit substrate made of the laminate according to claim 8.
